(19) United States
(12) Patent Application Publication
(10) Pub. No.: US 2009/0301446 A1
(43) Pub. Date: Dec. 10, 2009

(54) BLOW-BY GAS REFLUX APPARATUS FOR ENGINES WITH SUPERCHARGERS

(75) Inventors: Hiroshi ASANUMA, Chita-shi (JP); Hirokazu KONOHARA, Inazawa-shi (JP); Naoya OKADA, Kasugai-shi (JP)

Correspondence Address: DENNISON, SCHULTZ & MACDONALD, 1727 KING STREET, SUITE 105, ALEXANDRIA, VA, 22314, US

(73) Assignees: AISAN KOGYO KABUSHIKI KAISAH, Obu-shi (JP); TOYOTA JIDOSHA KABUSHIKI KAISHA, Toyota-shi (JP)

(21) Appl. No.: 12/477,192

(22) Filed: Jun. 3, 2009

(30) Foreign Application Priority Data
Jun. 4, 2008 (JP) 2008-146590

(51) Int. Cl. F02B 33/00; F02B 25/06

(52) U.S. Cl. 123/559.1; 123/574; 123/573

(57) ABSTRACT

The present invention includes an air introduction device capable of introducing air into a crankcase of the engine during a supercharging operation of a supercharger, so that blow-by gas within the crankcase can be scavenged into the intake air passage.

This application claims priority to Japanese patent application serial number 2008-146590, the contents of which are incorporated herein by reference.

### BACKGROUND OF THE INVENTION

1. Field of the Invention

The present invention relates to blow-by gas reflux apparatus for engines (internal combustion engines) with superchargers.

2. Description of the Related Art

A known blow-by gas reflux apparatus for an engine with a supercharger is schematically shown in FIG. 6. As shown in FIG. 6, according to the known blow-by gas reflux apparatus, a compartment 101 is formed on an upper portion of an engine and communicates with a crank chamber. The compartment 101 includes a passage chamber 104 for draining oil contained in blow-by gas and a passage chamber 103 for draining oil contained in breathing air at different two positions from each other. The passage chamber 104 for the flow of the blow-by gas communicates with an intake air passage 113 on the downstream side of a throttle valve 112 via a PCV valve (positive crankcase ventilation valve) 115 and also communicates with an intake side of an air cleaner 106 via a check valve 116. The passage chamber 114 for the flow of the breathing air directly communicates with the intake side of the air cleaner 106. The PCV valve 115 and the check valve 116 are opened alternately under two different driving conditions including a driving condition producing a negative pressure within the intake air passage 113 and a driving condition producing a positive pressure.

According to the known blow-by gas reflux apparatus, when a turbocharger 117 is not operated (or when no supercharging operation is performed), the PCV valve 115 is opened and the check valve 116 is closed, because a negative pressure is produced within the intake air passage 113. Therefore, fresh air is drawn from the intake side of the air cleaner 106 into the compartment 101 via a hose 105 and the passage chamber 103. Within the compartment 101, the drawn air is mixed with blow-by gas, and air-gas mixture is introduced into the intake air passage 113 via the passage chamber 104 and a hose 111. On the other hand, when the turbocharger 117 is operated (or when a supercharging operation is performed), the PCV valve 115 is closed and the check valve 116 is opened, because a positive pressure is produced within the intake air passage 113 by the compressive operation of the turbocharger 117. Therefore, the blow-by gas accumulated within the compartment 101 is introduced into the intake side of the air cleaner 106 via the passage chamber 103 and the hose 105 or via the passage chamber 104 and the hose 114, Japanese Laid-Open Utility Model Publication No. 57-112010 discloses this type of known blow-by gas reflux apparatus.

According to the above known apparatus, when the supercharging operation is performed by the supercharger 117, the blow-by gas within the compartment 101 may be introduced into the intake side of the air cleaner 106 via the passage chamber 103 and the hose 105 or via the passage chamber 104 and the hose 114. However, no fresh air is introduced into the compartment 101. Therefore, the blow-by gas within the compartment 101 may not be scavenged or ventilated to be replaced with fresh air, causing potential deterioration of engine oil. When deterioration of engine oil occurs, the user of a vehicle must replace the engine oil short time after starting the use of the oil, Thus, the number of miles driven or the number of months for replacement after starting the use of the engine oil may be reduced.

Therefore, there is a need in the art for blow-by gas reflux apparatus that can ventilate or scavenge blow-by gas existing within a crank case during a supercharging operation for preventing or minimizing deterioration of engine oil.

### SUMMARY OF THE INVENTION

One aspect according to the present invention includes an air introduction device capable of introducing air into a crank case of the engine during a supercharging operation of a supercharger, so that blow-by gas within the crank case can be scavenged into the intake air passage.

### BRIEF DESCRIPTION OF THE DRAWINGS

FIG. 1 is a schematic view of a blow-by gas reflux apparatus according to a first embodiment of the present invention;

FIG. 2 is a view similar to FIG. 1 but showing the operation when no supercharging operation of a supercharge is performed;

FIG. 3 is a view similar to FIG. 1 but showing the operation when a supercharging operation of the supercharger is performed;

FIG. 4 is a schematic view of a blow-by gas reflux apparatus according to a second embodiment of the present invention;

FIG. 5 is a schematic view of a blow-by gas reflux apparatus according to a third embodiment of the present invention; and

FIG. 6 is a schematic view of a known blow-by gas reflux apparatus.

### DETAILED DESCRIPTION OF THE INVENTION

Each of the additional features and teachings disclosed above and below may be utilized separately or in conjunction with other features and teachings to provide improved blow-by gas reflux apparatus. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

In one embodiment, a blow-by gas reflux apparatus for an engine includes a supercharger, a first communication passage, a second communication passage, a PCV valve (positive crankcase ventilation valve) and an air introduction device. The supercharger is disposed within an intake air passage on an upstream side of a throttle device. The first communication passage communicates between inside of a crank case of the engine and inside of a downstream side passage portion of the intake air passage on a downstream side of the throttle device. The second communication passage communicates between inside of the crank case and inside of an upstream side passage portion of the intake air passage on an upstream side of the supercharger. The PCV valve is disposed within the first communication passage. The air introduction device can introduce air into the crank case during a supercharging operation of the supercharger, so that blow-by gas within the crank case can be scavenged into the intake air passage via the second communication passage.

The air introduction device may be operable to open the PCV valve during the supercharging operation of the supercharger, so that air having a positive pressure within the downstream side passage portion of the intake air passage on the downstream side of the throttle device can be introduced into the crank case via the first communication passage.

Alternatively, the air introduction device may include the PCV valve and a control unit. The PCV valve includes an electromagnetic flow control valve, and the control unit can control to open and close the PCV valve.

The blow-by gas reflux apparatus may further include an oil removing device disposed within the second communication passage and capable of removing oil contents contained in the blow-by gas.

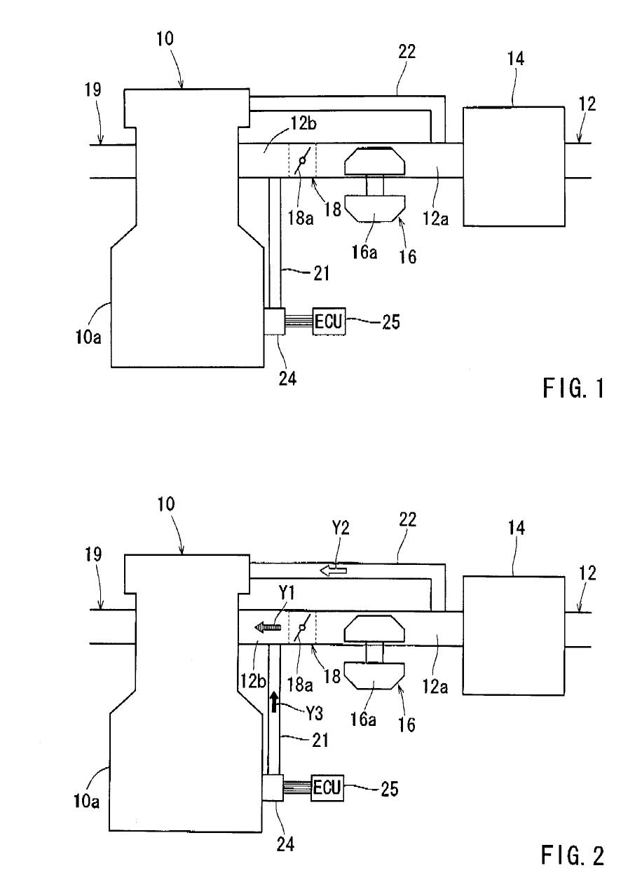

Embodiments of the present invention will now be described with reference to FIGS. 1 to 5. Referring to FIGS. 1 to 3, there is shown a blow-by gas reflux apparatus for an engine with a supercharger according to a first embodiment of the present invention. Referring to FIG. 1, an intake air passage 12 communicates with an intake port (not shown) of an engine (internal combustion engine) 10. An air cleaner 14, a supercharger 16 and a throttle device 18 are disposed within the intake air passage 12 and are arranged in this order in a direction from an upstream side of the intake air passage 12 toward a downstream side or the side of the engine 10. For example, the supercharger 16 may be a turbocharger having a turbine 16a and driven by the pressure of an exhaust gas of the engine 10. Other than the turbocharger, a supercharger driven by the drive force of the engine 10 or a motor-driven supercharger may be used as the supercharger 16. The throttle device 18 has a throttle valve 18a operable to open and close the intake air passage 12. An exhaust air passage 19 communicates with an exhaust port (not shown) of the engine 10.

A first communication passage 21 communicates between inside of a crank case 10a of the engine 10 and inside of a downstream-side passage portion 12b of the intake air passage 12, which is positioned on the downstream side of the throttle device 18. A second communication passage 22 communicates between inside of the crank case 10a and an upstream-side passage portion 12a of the intake air passage 12, which is positioned on the upstream side of the supercharger 16. The second communication passage 12 also communicates within a valve operating chamber (not shown) of a cylinder head of the engine 10. However, because the valve operating chamber communicates within the crankcase 10a, the term “crankcase” in this specification will be used to include the valve operating chamber

a PCV valve (positive crankcase ventilation valve) 24 constituted by an electromagnetic flow control valve is disposed within the first communication passage 21. A control unit 25 is constituted by an electronic control circuit (hereinafter called “ECU 25”) and electrically connected to the PCV valve 24, so that the PCV valve 24 is opened closed by the control of the control unit 25. More specifically, by the control of the ECU 25, the PCV valve 24 is opened proportionally to the pressure within the first communication passage 21 (more specifically, the opening degree of the PCV valve 24 decreases as the negative pressure within the first communication passage 21 increases) during the time when no supercharging operation is performed, while the PCV valve 24 is opened proportionally to a supercharging pressure during the supercharging operation. The PCV valve 24 and the ECU 25 serve as a fresh air introduction device as will be explained later.

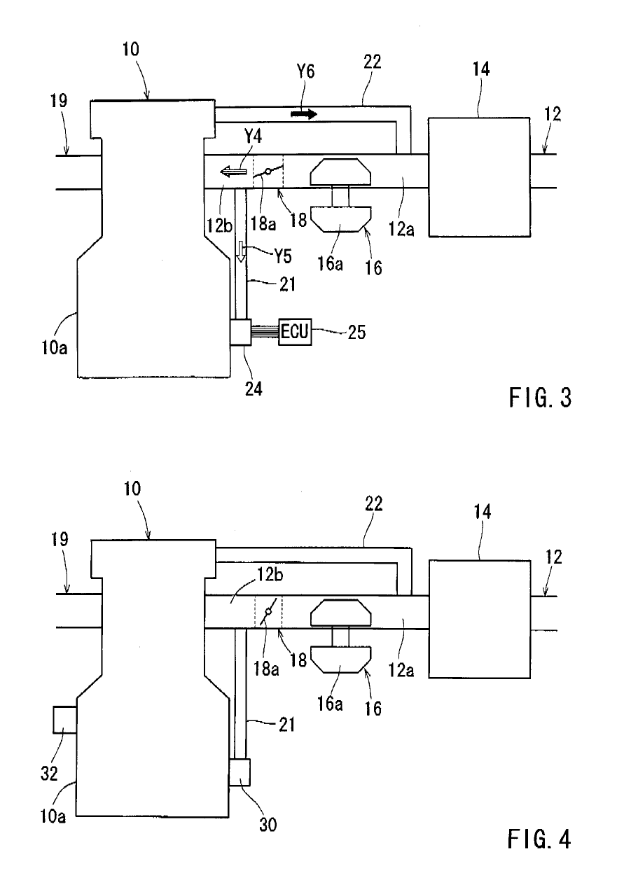

The operation of the above blow-by bas reflux apparatus will now be described with reference to FIGS. 2 and 3. FIG. 2 is an explanatory view showing the flow of fresh air and blow-by gas during the time when no supercharging operation is performed. FIG. 3 is an explanatory view showing the flow of fresh air and blow-by gas during the supercharging operation.

Referring to FIG. 2, when no supercharging operation is performed by the supercharger 16, a negative pressure may be produced within the downstream-side passage portion 12b of the intake air passage 12 on the downstream side of the throttle valve 18 (see arrow Y1 in FIG. 2). In addition, the PCV valve 24 is opened proportionally to the pressure within the first communication passage 21 by the control of the ECU 25. Therefore, intake air or fresh air may be introduced from the passage portion 12a of the intake air passage 12 on the upstream side of the supercharger 16 into the crankcase 10a via the second communication passage 22 (see arrow Y2 in FIG. 2). Hence, brow-by gas that may exist within the crankcase 10a can be scavenged or refluxed into the downstream-side passage portion 12b of the intake air passage 12 on the downstream side of the throttle device 18 via the second communication passage 22 (see arrow Y3). As a result, the blow-by gas within the crankcase 10a can be ventilated.

On the other hand, referring to FIG. 3, when the supercharging operation is performed by the supercharger 16, a positive pressure may be produced within the downstream-side passage portion 12b of the intake air passage 12 on the downstream side of the throttle valve 18 by the compressive operation of the supercharger 16 (see arrow Y4 in FIG. 3). In addition, the PCV valve 24 is opened in proportion to the supercharging pressure of the supercharger 16 under the control of the ECU 25. Therefore, intake air or fresh air may be introduced from the downstream-side passage portion 12b of the intake air passage 12 on the downstream side of the throttle valve 18 into the crankcase 10a via the first communication passage 21 (see arrow Y5 in FIG. 3). Hence, brow-by gas that may exist within the crankcase 10a can be scavenged or refluxed into the upstream-side passage portion 12a of the intake air passage 12 on the upstream side of the supercharger 16 via the second communication passage 22 (see arrow Y6 in FIG. 3). As a result, the blow-by gas within the crankcase 10a can be ventilated or scavenged.

According to the blow-by gas reflux apparatus for the engine 10 having the supercharger 16 of this embodiment, during the supercharging operation of the supercharger 16, the PCV valve 24 is opened under the control of the ECU 24 to introduce fresh air into the crankcase 10a via the first communication passage 21, so that blow-by gas that may exist within the crankcase 10 can be scavenged into the intake air passage 12 via the second communication passage 22. Because the blow-by gas within the crankcase 10a can be ventilated or scavenged during the supercharging operation of the supercharger 16, it is possible to prevent potential degradation of engine oil. Hence, the time (or the number of miles driven or the number of months) for replacement of engine oil of the vehicle after starting its use may not be shortened.

In addition, because the PCV valve 24 is opened under the control of the ECU 25 during the supercharging operation (see FIG. 3), intake air having a positive pressure within the downstream-side passage portion 12b of the intake air passage 12 on the downstream side of the throttle device 18 can be introduced into the crankcase 10a as a fresh air via the first communication passage 21.

Further, the PCV valve 24 (the electromagnetic flow control valve in this embodiment) and the ECU 25 (control unit) constitute a fresh air introduction device, in which the PCV valve 24 (electromagnetic flow control valve) can be opened and closed, when needed or in response to the supercharging pressure, under the control of the ECU 25.

In place of the electromagnetic flow control valve controlled by the ECU 25, the PCV valve 24 may be a mechanically controlled PCV valve that is opened depending on or by a positive pressure produced during the supercharging operation of the supercharger 16 (see FIG. 3). In such a case, the fresh air introduction device can be constituted by the PCV valve and the positive pressure produced during the supercharging operation.

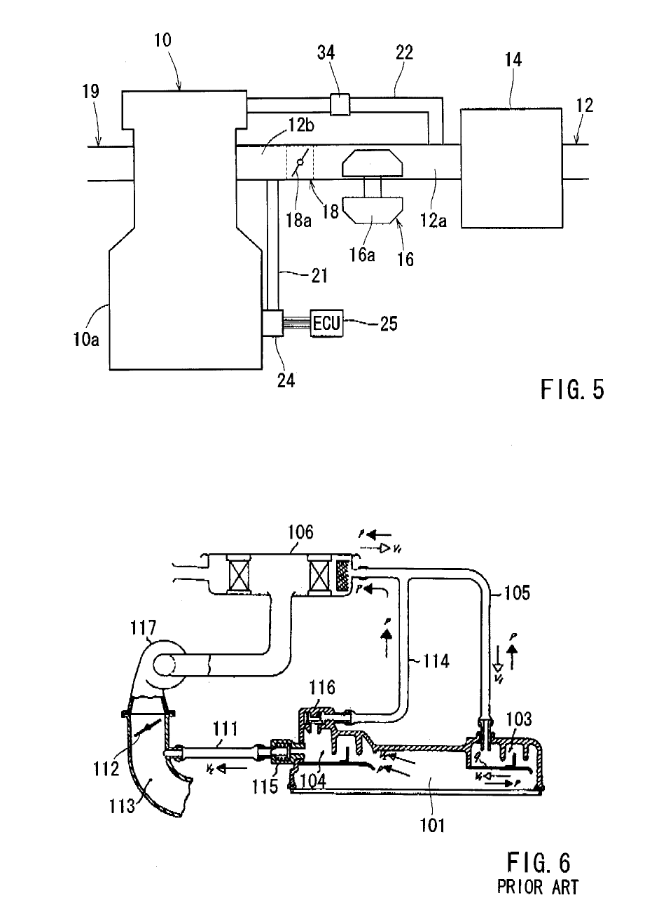

Second and third embodiments will now be described with reference to FIGS. 4 and 5. The second and third embodiments are modifications of the first embodiment. Therefore, in FIGS. 4 and 5, like members are given the same reference numerals as the first embodiment and the description of these members will not be repeated.

A blow-by gas reflux apparatus according to the second embodiment is shown in FIG. 4. In the blow-by gas reflux apparatus of the second embodiment, the PCV valve 24 is replaced with a PCV valve 30 that is opened when a negative pressure is produced within the intake air passage 12 and is closed when a positive pressure is produced within the intake air passage 12 in the same manner as the PCV valve 115 of the known apparatus (see FIG. 6). A fresh air introduction device 32 is incorporated for introducing fresh air into the crankcase 10a of the engine 10. The fresh air introduction device 32 may be an air pump, an air compressor or any other air supply device that can supply fresh outside air into the crankcase 10a when the supercharger 16 performs the supercharging operation.

Also with the second embodiment, during the supercharging operation of the supercharge 16, the fresh air supplied from the fresh air introduction device 32 can scavenge blow-by gas existing within the crankcase 10a into the intake air passage 12 via the second communication passage 22. Therefore, the blow-by gas within the crankcase 10a can be scavenged during the operation of the supercharge 16, so that potential deterioration of engine oil can be prevented or minimized.

The third embodiment will now be described with reference to FIG. 5 showing a blow-by gas reflux apparatus according to the third embodiment. In this embodiment, an oil removing device 34 is disposed within the second communication passage 22 for removing the oil contents from the blow-by gas. The oil removing device 34 may be an oil trapper, an oil mist separator or any other suitable device.

According to this embodiment, oil contents that may be contained in the blow-by gas flowing through the second communication passage 22 can be removed by the oil removing device 34. Therefore, it is possible to prevent or minimize potential defective operations of the supercharger 16, the throttle device 18, etc., which may be caused by the oil contents. The oil separating device 34 may also be provided within the second communication passage 22 in the second embodiment shown in FIG. 4.

This invention claims:

1. A blow-by gas reflux apparatus for an engine, comprising:
a supercharger disposed within an intake air passage on an upstream side of a throttle device:
a first communication passage communicating between inside of a crankcase of the engine and inside of a downstream-side passage portion of the intake air passage on a downstream side of the throttle device;
a second communication passage communicating between inside of the crankcase and inside of an upstream side passage portion of the intake air passage on an upstream side of the supercharger;
a PCV valve disposed within the first communication passage; and
an air introduction device capable of introducing air into the crankcase during a supercharging operation of the supercharger, so that blow-by gas within the crankcase can be scavenged into the intake air passage via the second communication passage.

2. The blow-by gas reflux apparatus as in claim 1, wherein the air introduction device is operable to open the PCV valve during the supercharging operation of the supercharger, so that air having a positive pressure within the downstream-side passage portion of the intake air passage on the downstream side of the throttle device can be introduced into the crankcase via the first communication passage.

3. The blow-by gas reflux apparatus as in claim 2, wherein the air introduction device comprises the PCV valve and a control unit, wherein the PCV valve comprises an electromagnetic flow control valve, and the control unit can control to open and close the PCV valve.

4. The blow-by gas reflux apparatus as in claim 1, further comprising an oil removing device disposed within the second communication passage and capable of removing oil contents contained in the blow-by gas.

5. The blow-by gas reflux apparatus as in claim 2, further comprising an oil removing device disposed within the second communication passage and capable of removing oil contents contained in the blow-by gas.

6. The blow-by gas reflux apparatus as in claim 3, further comprising an oil removing device disposed within the second communication passage and capable of removing oil contents contained in the blow-by gas.

7. An apparatus comprising:
an intake air passage for supplying intake air into an engine;
a supercharger disposed within the intake air passage; and
an air introduction device capable of introducing air into a crankcase of the engine during a supercharging operation of the supercharger, so that blow-by gas within the crankcase can be scavenged into the intake air passage.

8. The apparatus as in claim 7, wherein the air introduction device comprises:
a PCV valve disposed within a first communication passage communicating between inside of the crankcase and inside of the intake air passage,
a second communication passage communicating between inside of the crankcase and the inside of the intake air passage separately from the first communication passage; and
a control unit coupled to the PCV valve, so that the PCV valve can be opened under the control of the control unit during the supercharging operation, so that air within the intake air passage is introduced into the crankcase via the first communication passage and the blow-by gas within the crank case is scavenged into the intake air passage via the second communication passage.

9. The apparatus as in claim 8, wherein the PCV valve is an electromagnetic flow control valve.

10. The apparatus as in claim 8, further comprising a throttle device disposed within the intake air passage, and wherein the first communication passage communicates with inside of the intake air passage on a down stream side of the throttle device.

11. The apparatus as in claim 7, further comprising a throttle valve disposed within the intake air passage on a downstream side of the supercharger, wherein the air introduction device comprises a PCV valve disposed within a first communication passage communicating between inside of the crankcase and inside of the intake air passage, and the PCV valve is operable based on a pressure within the intake air passage on the downstream side of the throttle device.

12. The apparatus as in claim 7, wherein the air introduction device comprises a compressed air supply device directly coupled to the crankcase.

13. The apparatus as in claim 8, wherein the second communication passage communicates between inside of the crankcase and the intake air passage on an upstream side of the supercharger.

14. The apparatus as in claim 7, further comprising an oil removing device capable of removing oil contents contained in the blow-by gas.
